(19) United States
(12) Patent Application Publication
(10) Pub. No.: US 2012/0038738 A1
(43) Pub. Date: Feb. 16, 2012

(54) GAZE CORRECTING APPARATUS, A METHOD OF VIDEOCONFERENCING AND A VIDEOCONFERENCING SYSTEM

(75) Inventor: Kim N. Matthews, Warren, NJ (US)

(73) Assignee: Alcatel-Lucent USA, Incorporated, Murray Hill, NJ (US)

(21) Appl. No.: 12/855,186

(22) Filed: Aug. 12, 2010

(51) Int. Cl. H04N 7/15; H04N 5/225

(52) U.S. Cl. 348/14.1; 348/335; 348/E05.024; 348/E07.083

(57) ABSTRACT

This disclosure provides an apparatus for correcting gaze, a videoconferencing system and a method of videoconferencing. In one embodiment, the apparatus includes: (1) a monitor configured to provide a remote image for viewing, (2) a camera located in front of the monitor and positioned to face the monitor and capture a local image reflected therefrom and (3) a light filter positioned between the camera and the monitor to reduce light originating from the monitor on the camera.

### TECHNICAL FIELD

This application is directed, in general, to interactive video displays, such as, a videoconferencing terminal.

### BACKGROUND

This section introduces aspects that may be helpful in facilitating a better understanding of the disclosure. Accordingly, the statements of this section are to be read in this light and are not to be understood as admissions about what is in the prior art or what is not in the prior art.

Communication via computer networks frequently involves far more than transmitting text. Computer networks, such as the Internet, can also be used for audio communication and visual communication. Still images and video are examples of visual data that may be transmitted over such networks.

One or more cameras may be coupled to a computing device, such as a personal computer (PC), to provide visual communication. The camera or cameras can then be used to transmit real-time visual information, such as video, over a computer network. Dual transmission can be used to allow audio transmission with the video information. Whether in one-to-one communication sessions or through videoconferencing with multiple participants, participants can communicate via audio and video in real time over a computer network (i.e., voice-video communication).

During video conferences, the cameras and images of remote users are physically separate. This leads to participants appearing not to look at the camera but to an off-axis location, which many video conferencing participants find uncomfortable and annoying. This gaze misdirection is often cited as one of the major subjective issues in conferencing, especially during one-on-one meetings. This problem requires that, relative to the user, the direction of the image of the remote user and the direction of the camera should be coincident, which is generally impractical.

### SUMMARY

One aspect provides an apparatus. In one embodiment, the apparatus includes: (1) a monitor configured to provide a remote image for viewing, (2) a camera located in front of the monitor and positioned to face the monitor and capture a local image reflected therefrom and (3) a light filter positioned between the camera and the monitor to reduce light originating from the monitor on the camera.

In another aspect, a method of videoconferencing is provided. In one embodiment, the method includes: (1) providing a remote image from a first location on a monitor at a second location, (2) simultaneously with the providing, capturing a local image reflected from the monitor on a camera, the camera located in front of the monitor and positioned to face the monitor, the local image for display at the first location and (3) filtering the local image reflected from the monitor employing a light filter positioned between the camera and the monitor to reduce light originating from the monitor onto the camera.

In yet another aspect, a videoconferencing system is disclosed. In one embodiment, the videoconferencing system includes a first videoconferencing terminal connectable to support a videoconferencing session video with a second videoconferencing terminal via a telecommunications network, wherein the first terminal has: (1) a microphone configured to generate an audio signal based on acoustic energy received thereby, (2) a speaker configured to generate acoustic energy based on an audio signal received thereby, (3) a monitor associated with the speaker and configured to provide a remote image from the second videoconferencing terminal, (4) a camera associated with the microphone and located in front of the monitor, the camera positioned to face the monitor and capture a local image reflected therefrom, the local image for display at the second videoconferencing terminal and (5) a light filter positioned between the camera and the monitor to reduce light originating from the monitor on the camera.

### BRIEF DESCRIPTION

Reference is now made to the following descriptions of embodiments, provided as examples only, taken in conjunction with the accompanying drawings, in which:

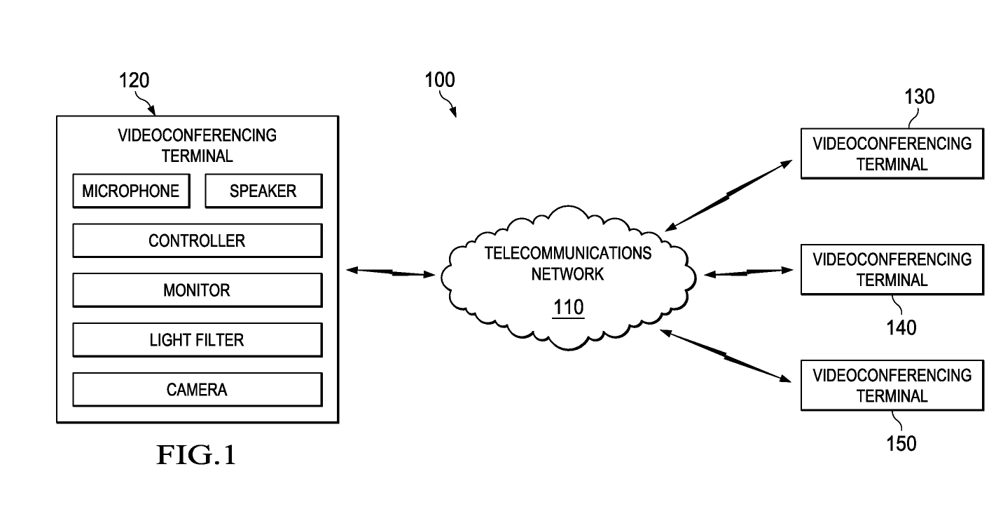

FIG. 1 is a schematic block diagram of an embodiment of a videoconferencing infrastructure within which a videoconferencing terminal constructed according to the principles of the disclosure may operate;

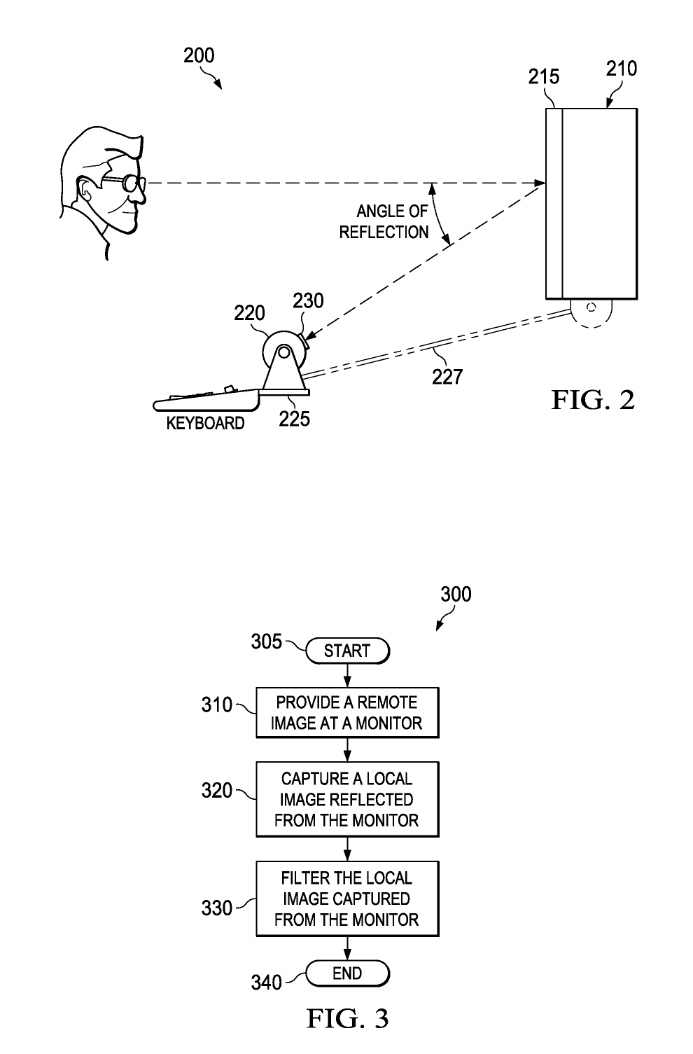

FIG. 2 is a side elevation view of an embodiment of a videoconferencing terminal, e.g., of the videoconferencing infrastructure of FIG. 1, constructed according to the principles of the disclosure; and

FIG. 3 is a flow diagram of one embodiment of a method of videoconferencing carried out according to the principles of the disclosure.

### DETAILED DESCRIPTION

Even with voice-video communication, videoconferencing sessions can seem rigid with strained interaction between participants. To improve interaction and provide an immersive feel for users, various devices have been used. For example, a camera is often positioned as close as possible to the image of the remote user. Other conventional devices may add a secondary semi-reflective surface to a monitor at an angle of 45 degrees to reflect the image of a user to a camera positioned to the side of the monitor (i.e., a reversed teleprompter). Some conventional devices have attempted to place a camera behind a monitor and obtain an image of the user by either using a hole in the monitor or by modulating the transparency of the monitor. These conventional devices, however, provide approximate solutions that can be distracting to the users, cause poor image quality or increase the size of the display to uncomfortable proportions.

Disclosed herein is an apparatus, such as a computer terminal, that employs the front surface or screen of a monitor (e.g., a liquid crystal display (LCD) monitor) as a low efficiency mirror and a camera (e.g., a video camera) either located above, below or to the side of the monitor to capture an image of the user. The computer terminal may be used for videoconferencing (i.e., a videoconferencing terminal). The addition of a light filter, such as a polarizing filter, in front of the camera removes the component of light coming from or originating from the monitor, leaving just the reflected image. The component of light originating from the monitor may be a remote image being displayed on the monitor.

The light filter is located between the camera and the monitor. As such, the light filter is positioned in front of the camera (i.e., located in front of the lens of the camera) to filter out unwanted light generated by the monitor. As disclosed below, the light filter may be attached to the camera, attached to another device such as a keyboard or may be an independent device that can support itself.

FIG. 1 is a schematic block diagram of one embodiment of a videoconferencing infrastructure 100 within which a videoconferencing terminal constructed according to the principles of the disclosure may operate. This embodiment of the videoconferencing infrastructure 100 is centered about a telecommunications network 110 that is employed to interconnect two or more videoconferencing terminals 120, 130, 140, 150 for communication of video signals or information, and perhaps also audio signals or information, therebetween. An alternative embodiment of the videoconferencing infrastructure 100 is centered about a computer network, such as the Internet. Still another embodiment of the videoconferencing infrastructure 100 involves a direct connection between two videoconferencing terminals, e.g., connection of the videoconferencing terminals 120, 130 via a plain old telephone (POTS) network. As represented in the videoconferencing terminal 120, the videoconferencing terminals 120, 130, 140, 150, may include components typically included in a conventional videoconferencing terminal, such as, a microphone, a speaker, a monitor and controller. Additionally, the videoconferencing terminals 120, 130, 140, 150, may include a camera located in front of the monitor and positioned to face the monitor and capture an image reflected therefrom. The front or viewing side of the monitor is the screen-side of the monitor where displayed images are viewed. A light filter is also located between the camera and the monitor. The light filter may be coupled to camera. In some embodiments, the light filter may be a self-supporting device with a base that allows the light filter to be positioned independently between the monitor and the camera. These embodiments provide a configuration that allows the light filter to be fixed to maintain a set-up for operation and also allow different cameras to be used. The light filter may also be coupled to a keyboard associated with videoconferencing terminal 120. In the various embodiments, the light filter may be fastened or positioned employing conventional means.

The microphone can be configured to generate an audio signal based on acoustic energy received thereby, and the speaker can be configured to generate acoustic energy based on an audio signal received thereby. The monitor can include a display screen that provides a visual output and the controller can be configured to direct the operation of the terminal. The videoconferencing terminals 120, 130, 140, 150, may be computer terminals, including but not limited to, a personal computer, a laptop, a computing pad, a personal digital assistant (PDQ) or a mobile telephone.

FIG. 2 is a side elevation view of an embodiment of a videoconferencing terminal 200, e.g., of the videoconferencing infrastructure of FIG. 1, constructed according to the principles of the disclosure. The videoconferencing terminal 200 includes a monitor 210, a camera 220 and a light filter 230.

The monitor 210 includes a screen 215 and is configured to provide an image for viewing, such as, a remote image communicated over the telecommunications network 110 of FIG. 1 from a remote videoconferencing terminal. The monitor 210 may be a flat panel display (FPD) monitor. In one embodiment, the monitor 210 is a liquid crystal display (LCD) monitor. In an alternative embodiment, the monitor 210 is a liquid-crystal-on-silicon (LCoS) monitor. In further alternative embodiments, the monitor 210 is another conventional or later-developed FPD technology that allows filtered images, such as, a monitor that provides polarized images. Those skilled in the pertinent art understand the structure and operation of conventional FPDs.

The camera 220 is located in front of the monitor 210 and positioned to face the monitor 210 and capture an image reflected therefrom. The camera 220 may be a conventional webcam. The local image may be the face of a local user in front of the monitor 210. The local user may be, for example, employing the monitor 210 for a videoconferencing session or recording a video blog. The camera 220 may be coupled to the monitor 210 via conventional audio-video cable to transmit the captured image to the monitor 210 for, for example, transmission to another terminal for video conferencing. Wireless connections may also be employed.

The camera 220 includes a base 225 that is designed to support the camera 220 and allow the camera 220 to be tilted to adjust the field of view. One skilled in the pertinent art will understand the structure and operation of a base that allows the field of view of the camera 220 to be adjusted. The field of view may be adjusted to align with the angle that the local image is reflected (i.e., the angle of reflection) from the monitor 210.

As illustrated in FIG. 2, the camera 220 may be coupled to a keyboard associated with the monitor 210. The camera 220 may be coupled to the keyboard via a conventional means. The camera 220 may also be fastened to the monitor 210 via an arm 227 as indicated by the dashed line in FIG. 2. The distance the camera 220 is extended from the monitor 210 or positioned in front of the monitor 210 may be based on the type of monitor 210 (e.g., the size of the monitor 210). The distance may be known based on experimentation. In some embodiments, a particular distance for various types of displays may be marked on the arm 227 to position the camera 220. The arm 227 may be mechanically coupled to the monitor 210 through conventional means and may be attached at various locations on the monitor 210 that allow the camera 220 to be positioned in front of the monitor 210. For example with respect to the monitor 210, the arm 227 may support the camera 220 from the bottom of the monitor 210. In other embodiments, the arm 227 may support the camera 210 from sides of the monitor 210 of from the top of the monitor 210. Additionally, the camera 220 may be attached to the top side of the keyboard, to the left side or, as illustrated, to the right side of the keyboard.

The light filter 230 is positioned between the camera 220 and the monitor 210 to reduce light originating from the monitor 210 onto the camera 220. The light filter 230 is detached from the monitor 210 (i.e., not attached to the screen of the monitor) and, in FIG. 2, is coupled to the front of the camera 220. In other embodiments, the light filter 230 may be a self-supporting device with a base that allows the light filter 230 to be positioned independently between the monitor 210 and the camera 220. Alternatively, the light filter 230 may be coupled to the keyboard or the arm 227. These embodiments provide a configuration that allows the light filter 230 to be fixed to maintain a set-up for operation and also allow different cameras to be used. The light filter 230 may be fastened or positioned employing conventional means.

In one embodiment, the light filter 230 is a polarizing filter. The polarizing filter may be a linearly polarizing filter or a circularly polarizing filter. For example, the light filter 230 may be a linearly polarizing filter that transmits one of two states of linearly polarized light. Light originating from the monitor 210 is polarized in a known state (e.g., red, blue and green light may be produced with the same linear polarization), as such, a linear polarizing filter can be configured with its transmission axis orthogonal to the known state to prevent light originating from the monitor 210 passing through the light filter 230 to the camera 220. For circularly polarizing, a circular polarization filter may be configured with a clockwise or anticlockwise transmission filter to prevent light originating from the monitor 210 passing through the light filter 230 to the camera 220. Employing a circular polarization filter may reduce misalignment effects of the light filter 230. One skilled in the art will understand how to make and attach such a linear polarizing filter to a surface.

FIG. 3 is a flow diagram of one embodiment of a method of videoconferencing carried out according to the principles of the disclosure. In one embodiment a videoconferencing terminal as disclosed herein with respect to FIG. 1 or FIG. 2, (e.g., including a monitor, a camera and a light filter) may be employed for the videoconferencing. The method begins in a step 305.

In a step 310, a remote image from a first location is provided on a monitor at a second location. The first location may be a remote location from the monitor. In one embodiment, the remote image may be communicated over a telecommunications network to the monitor. In some embodiments, the first location and the second location may be located proximate each other. For example, the first location and the second location may be located in the same building or may be separated by a wall. The remote image may originate from a videoconferencing terminal coupled to the telecommunications network.

While providing the remote image, a local image reflected from the monitor (or a screen of the monitor) is captured on the camera in a step 320. The camera is located in front of the monitor and positioned to face the monitor. The local image is reflected from the display at an angle of reflection and the camera captures the local image at the angle of reflection. The camera may be mechanically coupled to the monitor. The local image is captured to be displayed at the first location. As such, users at the first location and the second location may participate in a video conference. For example, the local image may be of a local user of the monitor and the camera is positioned between the local user and the monitor.

While capturing the local image and providing the remote image, the local image reflected from the monitor is filtered in a step 330. The local image may be filtered employing a polarizing filter positioned between the camera and the monitor. The polarizing filter may be a linear or a circular polarization filter. The filtering reduces the amount of light originating from the monitor. The method 300 then ends in a step 340.

Those skilled in the art to which the application relates will appreciate that other and further additions, deletions, substitutions and modifications may be made to the described embodiments. Additional embodiments may include other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

What is claimed is:

1. An apparatus, comprising:
a monitor configured to provide a remote image for viewing;
a camera located in front of said monitor and positioned to face said monitor and capture a local image reflected therefrom; and
a light filter positioned between said camera and said monitor to reduce light originating from said monitor on said camera.

2. The apparatus as recited in claim 1 wherein said light filter is a polarizing filter.

3. The apparatus as recited in claim 2 wherein said light filter is detached from said monitor.

4. The apparatus as recited in claim 1 wherein said camera is positioned below said monitor.

5. The apparatus as recited in claim 1 wherein said camera is positioned between a local user of said monitor and said monitor.

6. The apparatus as recited in claim 1 wherein said local image is reflected from said monitor at an angle of reflection and said camera is aligned to capture said local image at said angle of reflection.

7. The apparatus as recited in claim 1 wherein said camera is mechanically coupled to said monitor.

8. A method of videoconferencing, comprising:
providing a remote image from a first location on a monitor at a second location;
simultaneously with said providing, capturing a local image reflected from said monitor on a camera, said camera located in front of said monitor and positioned to face said monitor, said local image for display at said first location; and
filtering said local image reflected from said monitor employing a light filter positioned between said camera and said monitor to reduce light originating from said monitor.

9. The method as recited in claim 8 wherein said light filter is a polarizing filter.

10. The method as recited in claim 9 wherein said light filter is detached from said monitor.

11. The method as recited in claim 8 wherein said camera is positioned below said monitor.

12. The method as recited in claim 8 wherein said local image is of a local user of said monitor and said camera is positioned between said local user and said monitor.

13. The method as recited in claim 8 wherein said local image is reflected from said monitor at an angle of reflection and said camera captures said local image at said angle of reflection.

14. The method as recited in claim 8 wherein said camera is mechanically coupled to said monitor.

15. A videoconferencing system, comprising:
a first videoconferencing terminal connectable to support a videoconferencing session video with a second videoconferencing terminal via a telecommunications network, wherein said first terminal includes:
a microphone configured to generate an audio signal based on acoustic energy received thereby,
a speaker configured to generate acoustic energy based on an audio signal received thereby,
a monitor associated with said speaker and configured to provide a remote image from said second videoconferencing terminal,
a camera associated with said microphone and located in front of said monitor, said camera positioned to face said monitor and capture a local image reflected therefrom, said local image for display at said second videoconferencing terminal, and
a light filter positioned between said camera and said monitor to reduce light originating from said monitor on said camera.

16. The video conferencing system as recited in claim 15 wherein said light filter is a polarizing filter.

17. The video conferencing system as recited in claim 15 wherein said light filter is detached from said monitor.

18. The video conferencing system as recited in claim 15 wherein said camera is positioned below said monitor.

19. The video conferencing system as recited in claim 15 wherein said camera is positioned between a local user of said monitor and said monitor.

20. The video conferencing system as recited in claim 15 wherein said local image is reflected from said monitor at an angle of reflection and said camera is aligned to capture said local image at said angle of reflection.
